(19) United States
(12) Patent Application Publication
(10) Pub. No.: US 2006/0245103 A1
(43) Pub. Date: Nov. 2, 2006

(54) Storage device system operating based on system information, and method for controlling thereof

(76) Inventors: Koichi Ueno, Odawara (JP); Seiki Morita, Odawara (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/167,469

(22) Filed: Jun. 28, 2005

(30) Foreign Application Priority Data
Apr. 27, 2005 (JP) 2005-128983

(51) Int. Cl. G11B 5/09

(52) U.S. Cl. 360/53

(57) ABSTRACT

The storage device system has a storage device to which system information related to the storage device system is written, and a determination unit determining the presence and absence of system information errors before operation based on system information written to the storage device is conducted. When an error is determined as a result of the determination of the system information written to one storage device of a plurality of storage devices, storage device can be closed, and system information written to another storage device is determined for the presence and absence of errors.

### CROSS-REFERENCE TO PRIOR APPLICATIONS

This application relates to and claims priority from Japanese Patent Application No. 2005-128983 filed on Apr. 27, 2005, the entire disclosure of which is incorporated herein by reference.

### BACKGROUND OF THE INVENTION

1. Field of the Invention

The present invention relates to a storage device operating based on system information.

2. Description of the Related Art

Storage device systems having a plurality of storage devices are known. Storage device systems are, for example, communicably connected with a host device, and data sent from the host device is written to the various storage devices of the storage device system.

Hard disk drives (hereafter referred to as ‘HDD’) are generally employed as storage devices. For example, SATA (Serial ATA) drives may be employed as HDDs (see, for example, Japanese Patent Application Laid-open No. 2004-348876).

Incidentally, various types of information can be stored in storage devices such as HDDs and the like, however, the so-called system information related to the storage device system is sometimes written to the storage device of the storage device system. The storage device system reads the system information from the storage device and operates based on that system information. The system information is therefore important information associated with whether or not the storage device system can operate normally, and when a system error occurs, there is a concern that the storage device system may malfunction (for example, there is the concern that data written from the host device may be destroyed).

A method of protecting data read or written by the host device (this type of data is frequently used by the user, and is therefore referred to as ‘user data’ for convenience) is to write user data to a plurality of storage devices using a RAID (Redundant Arrays of Independent Disks) method. However, it is not considered desirable to simply redeploy this method for writing system information, since, if system information is read prior to detection of removal of one of a plurality of storage devices, when operation is conducted based on this system information, operation will be conducted based on system information for which information elements written to the removed storage device are missing, and there is therefore there is a concern that a malfunction will occur.

Furthermore, a method is possible in which the reliability of system information can be maintained by writing system information to a storage device of high reliability (for example, a Fiber Channel HDD). However, since storage devices of high reliability are generally expensive, this method is not considered desirable for controlling storage device system costs.

One method of controlling storage device system costs is to mount an inexpensive storage device in place of the expensive storage device, however since the reliability of inexpensive storage devices is generally lower than for expensive storage devices, the problem of reliability of system information arises.

### SUMMARY OF THE INVENTION

Therefore, the object of the present invention is to improve reliability of system information. In practice, for example, the object of the present invention is to maintain the reliability of system information despite writing this system information to a storage device of low reliability.

The storage device system according to one aspect of the present invention operates based on system information related to the storage device system, and has a determination unit for determining the presence and absence of system information errors prior to operation based on system information written to the storage device.

In one embodiment, the storage device system can have a plurality of storage devices storing the same system information. The determination unit can determine errors of the system information written to one storage device of the plurality of storage devices, and if, as a result, an error is detected, storage device can be closed and system information written to another storage device is determined for the presence and absence of errors.

In one embodiment, the storage device to which the system information is written may be a SATA HDD or an SAS HDD.

In one embodiment, the storage device system can also have a write unit writing the system information to the storage device. The determination unit can read the system information from the storage device, compare the read system information with the written system information, and determine an error if one system information does not match to the other system information.

In one embodiment, the storage device system may also have a further write unit writing the system information and a system information error present/absent determination code to the storage device. The determination unit can read the system information and the error present/absent determination code from the storage device, and use the read error present/absent determination code to determine the presence and absence of system information errors.

In one embodiment, the error present/absent code may be a system information check sum. The determination unit can read the system information and the system information check sum from the storage device, compute the check sum of the read system information, compare the computed check sum with the read check sum, and determine an error if one check sum does not match the other check sum.

In one embodiment, the error present/absent determination code may be at least two specific codes (for example, guarantee codes as described below). The determination unit can read the system information and the two specific codes from the storage device, compare the two specific codes, and determine an error if one specific code does not match the other specific code.

In one embodiment, the system information may include a plurality of system information elements. The determination unit can determine the presence and absence of errors for each of at least one system information elements.

In one embodiment, the plurality of system information elements may differ in type, update timing, or read timing. The determination unit can determine the presence and absence of errors of system information elements based on type, update timing, or read timing.

In one embodiment, the storage device system may also have a write unit writing the error present/absent determination code for each of at least one system information elements. The error present/absent determination code may be by type, update timing, or read timing.

In one embodiment, the determination unit can select whether or not the prescribed system information element of the plurality of system information elements is to be determined for the presence and absence of errors, and if determination is selected, the prescribed system information element can be determined for the presence and absence of errors.

In one embodiment, the determination unit may be a processor reading and executing a computer program. The system information may include the computer program, configuration information related to the configuration of the storage device system, and analysis data for analyzing faults occurring in the storage device system, as the plurality of system information elements. The determination unit always determines the presence and absence of errors of the computer program and the configuration information, and when determination of analysis data for errors is selected, the prescribed system information element can be determined for the presence and absence of errors.

In one embodiment, the storage device system can also have a storage area which can store the degree of importance of each of the plurality of system information elements. The determination unit references this storage area, and determines the presence and absence of errors of system information elements beginning with those having a high degree of importance.

In one embodiment, the storage device system is communicably connected to a host device sending access requests, and can also have a plurality of storage devices including storage devices to which the system information is written, a computing unit computing error present/absent determination codes for all or part of the system information, a write unit writing the system information and error present/absent determination codes to the storage device, and a control unit reading and writing data to and from at least one storage device of a plurality of storage devices based on access requests from the host device. When the control unit is not processing based on access requests, the computing unit may compute the error present/absent determination codes.

In one embodiment, the write unit may write system information and a plurality of types of error present/absent determination codes to the storage device. The determination unit may determine the presence and absence of system information errors using the plurality of types of error present/absent determination codes.

In one embodiment, the storage device system is communicably connected to a host device sending access requests, and can also have a plurality of storage devices including storage devices to which the system information is written, a control unit reading and writing data to and from at least one storage device of a plurality of storage devices based on access requests from the host device, and a cache area for temporarily storing data sent and received between at least one of a plurality of storage devices and the host device. The determination unit can determine the presence and absence of errors using a separate storage area from the cache area.

In one embodiment, the storage device system has a plurality of storage devices comprising a single RAID group, and may be communicably connected to a host device sending access requests. Each of at least two of the plurality of storage devices may be divided into a system area in which system information is written, and a user area accessed by the host device according to the access requests from the host device. The same system information may be written to each system area. The storage device system can either induce the host device not to recognize each system area, or induce the host device to recognize each system area as a write-prohibited area.

The afore-mentioned units such as the determination unit and the like can be realized with elements such as hardware, computer programs, or a combination of the two and the like. Furthermore, the processing executed by each unit may be conducted by a single element, or by a plurality of elements.

A method according to an aspect of the present invention is a storage device system control method operating based on system information related to the storage device system, in which system information is written to at least one storage device, and system information is determined for the presence and absence of errors before operation based on system information written to the storage device.

The computer program according to one aspect of the present invention writes system information to at least one storage device, and system information can be determined for the presence and absence of errors before operation based on system information written to the storage device. This computer program may be downloaded via a communications network, and may be read from a medium such as a CDROM or a DVD (Digital Video Disk or Digital Versatile Disk) and the like.

### BRIEF DESCRIPTION OF THE DRAWINGS

FIG. 1 shows the storage device system according to a first embodiment of the present invention;

FIG. 2A and FIG. 2B show the storage areas on each of the plurality of SATA HDDs 20;

FIG. 3A shows an example of the flow of processing conducted by the CPU 101 writing system information, and FIG. 3B is a descriptive diagram showing results of that write processing;

FIG. 4A shows an example of the flow of processing conducted by the CPU 101 when reading system information, and FIG. 4B is a descriptive diagram showing an example of that processing;

FIG. 5A shows a configuration example of the system area 22 in a second embodiment of the present invention, and FIG. 5B shows an example the flow of processing conducted by the CPU 101 when reading system information in the second embodiment of the present invention;

FIG. 6A shows an example of the flow of processing conducted by the CPU 101 reading system information in a third embodiment of the present invention, and FIG. 6B is a descriptive diagram of an example of that processing flow;

FIG. 7A shows an example of the flow of processing conducted by the CPU 101 writing system information in a fourth embodiment of the present invention, FIG. 7B is a descriptive diagram of the results of that write operation, and FIG. 7C shows an example of the flow of processing conducted by the CPU 101 when reading system information in the fourth embodiment of the present invention.

FIG. 8A shows an example of the flow of processing conducted in a fifth embodiment of the present invention, FIG. 8B is a descriptive diagram of a sixth embodiment of the present invention, and FIG. 8C is a descriptive diagram of a seventh embodiment of the present invention; and

FIG. 9A is a descriptive diagram of an eighth embodiment of the present invention, and FIG. 9B is a descriptive diagram of inducing the host device 3 not to recognize a system area.

### DESCRIPTION OF THE PREFERRED EMBODIMENTS

One embodiment of the present invention is described below in reference to the figures.

### First Embodiment

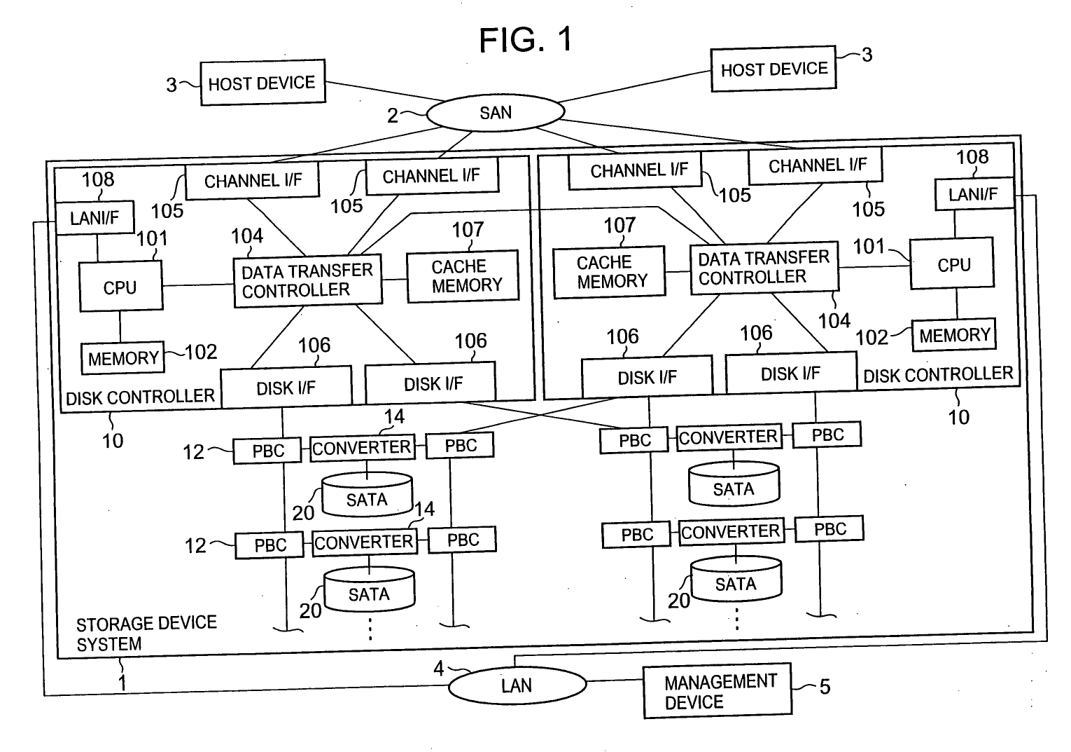

FIG. 1 shows the storage device system according to the first embodiment of the present invention.

The storage device system 1 has multiplexed disk controllers (for example, duplicated) 10 and 10, and a plurality of disk-type storage devices 20. Furthermore, the storage device system 1 is connected to at least one host device 3 and a management device 5. In practice, for example, the storage device system 1 is connected to at least one host device 3 via a SAN (Storage Area Network) 2, and connected to the management device 5 via a LAN (Local Area Network) 4.

The host device 3 is a computer device (for example, a personal computer) having hardware resources such as a CPU, a memory, and a display device and the like. The host device 3 can send read requests for read data, write requests, and write data, to the storage device system 1 (read requests and write requests are hereafter generally referred to as ‘access requests’).

The management device 5 is a computer device (for example, a personal computer) having hardware resources such as a CPU, a memory, and a display device and the like. Programs (not shown in figures), for example, can run on the management device 5, and the operating status of the storage device sub-system 1 can be understood, and operation of the storage device system 1 controlled, with the management program.

A client program such as a web browser and the like can also run on the management device 5, and operation of the storage device system 1 can also be controlled with a management program supplied from the storage device system 1 by a CGI (Common Gateway Interface) and the like.

In the storage device system 1, the host device 3 and the management device 5 may be connected via a shared network, or connected via dedicated lines. The storage device system 1 can be a RAID (Redundant Array of Independent Disks) system.

In the present embodiment, the disk-type storage devices 20 11. are HDDs (Hard Disk Drive), and in practice, are inexpensive SATA HDDs (HDDs having a SATA interface) generally considered to be of lower reliability than FC HDDs (HDDs having a Fiber Channel interface). For example, the certainty with which data to be written to the HDD 20 is written to the HDD 20 is not high, and furthermore, the certainty with which written data is read accurately (for example, the certainty that read data is accurate data) is also not high for the SATA HDDs 20. In this embodiment, system information being the basis of operation of the storage device system 1 is stored on SATA HDDs 20 considered to be of low reliability in this manner. Thus, the cost of the storage device system 1 can be controlled, and the reliability of system information can be maintained with the methods described below. System information is described in detail below.

Each disk controller 10 controls data I/O for the SATA HDDs 20. Each disk controller 10 has, for example, a CPU 101, a memory 102, a data transfer controller 104, a channel interface (‘interface’ is hereafter abbreviated as ‘I/F’) 105, a disk I/F 106, a cache memory 107, and a LAN I/F 108.

The memory 102 can store a variety of types of information.

Data sent and received between the channel I/F 105 and the disk I/F 106 (in other words, data sent and received between the host device 3 and the SATA HDDs 20) is temporarily stored in the cache memory 107.

The channel I/F 105 is an interface for the SAN 2, and for example, sends and receives data, and control signals to and from the host device 3, using the Fiber Channel protocol.

The disk I/F 106 is an interface for the SATA HDDs 20, and for example, sends and receives data and control signals to and from the SATA HDDs 20 using the Fiber Channel protocol.

The data transfer controller 104 is communicably connected with the other data transfer controller 104, and thus, data can be sent to and received from the other should be data transfer controller 104. The data transfer controller 104 controls data transfer between the CPU 101, the channel I/F 105, the disk I/F 106, and the cache memory 107. For example, the data transfer controller 104 transfers data written and read to and from the SATA HDDs 20 via the SAN 2 between the interfaces 105 and 106 via the cache memory 107.

The LAN I/F 108 is an interface for the LAN 4, and for example, sends and receives data and control signals to and from the management device 5 with the TCP/IP protocol.

The SATA HDDs 20 are connected to both duplicated disk controllers 10 so that the SATA HDDs 20 can be accessed from the other disk controller 10 when a fault occurs in one disk controller 10. In practice, for example, each SATA HDD 20 is connected to the disk I/F 106 of one disk controller 10 via a converter 14 converting from the FC (Fiber Channel) protocol the SATA protocol, and a port bypass circuit (hereafter referred to as ‘PBC’) 12, and to the disk I/F 106 of the other disk controller 10 via the converter 14 and the PBC 12. The converter 14 can have, for example, two ports connected to two PBCs 12 and 12, and can also function as a switch to select connection to either port.

By reading and executing computer programs in system information stored in the SATA HDDs 20, the CPU 101 can execute various types of processing. For example, when a read request is received from the host device 3, the CPU 101 temporarily writes read data written to the logical unit described below to the cache memory 107, and then reads that read data from the cache memory 107 and sends the read data to the host device 3. Furthermore, for example, when a write request and write data are received from the host device 3, the write data can be temporarily stored in the cache memory 107, and the CPU 101 can write the write data stored in the cache memory 107 to the logical unit in accordance with the write request.

The above is an outline of the storage device system according to the present embodiment. The present embodiment is described in detail below.

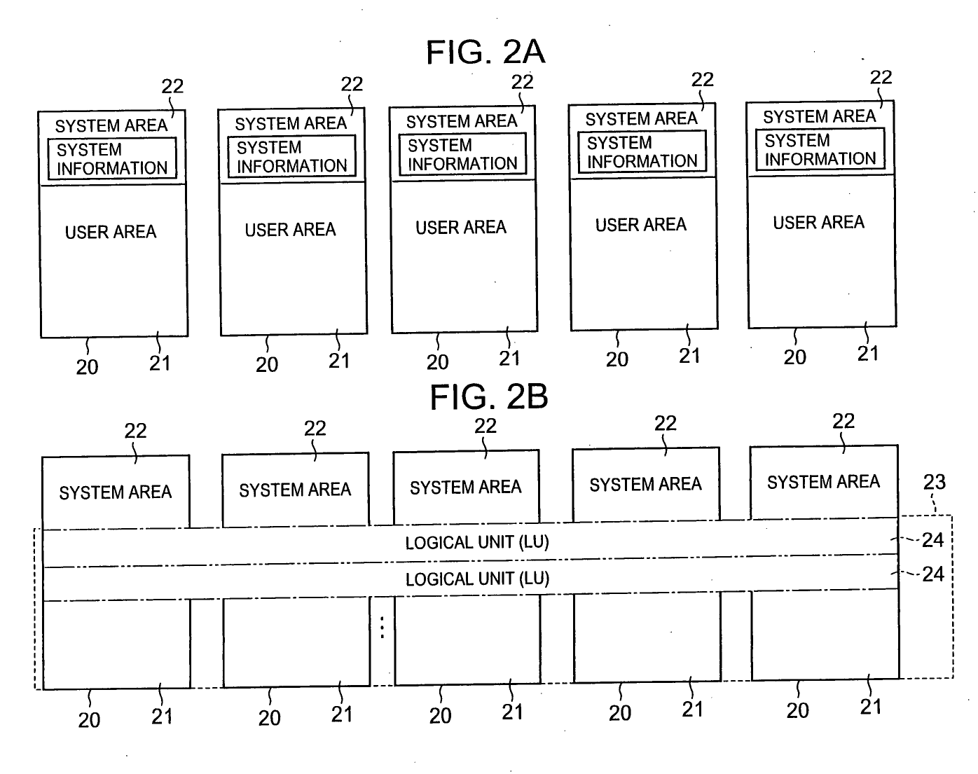

FIG. 2A and FIG. 2B show the storage areas on each of the plurality of SATA HDDs 20.

For example, a RAID group is comprised of a plurality of SATA HDDs 20 based on a RAID level. In practice, for example, when the RAID level is 5, a single RAID group is comprised of five SATA HDDs 20, as shown in FIG. 2A and 2B.

Each SATA HDD 20 has a system area in which system information related to the storage device system 1 is stored, and a user area 21 in which user data sent and received to and from the host device 3 is stored. In other words, in the present embodiment, some of the SATA HDDs 20 are used exclusively for storage of system information.

The same system information is stored in at least two of the plurality of system areas 22. Thus, for example, despite the occurrence of a fault in one of the SATA HDDs 20, the CPU 101 can acquire the same system information from another SATA HDD 20.

As shown in FIG. 2B, one or a plurality of logical units (hereafter abbreviated as ‘LU’) 24 are provided in the user area group 23 comprised of a plurality of user areas 21. By issuing an access request specifying an LUN (LU number), the host device 3 can read and write user data to and from the LU 24 corresponding to the LUN. Information indicating which LU 24 has which LUN in which SATA HDD 20 is one information element included in the configuration information in the system information.

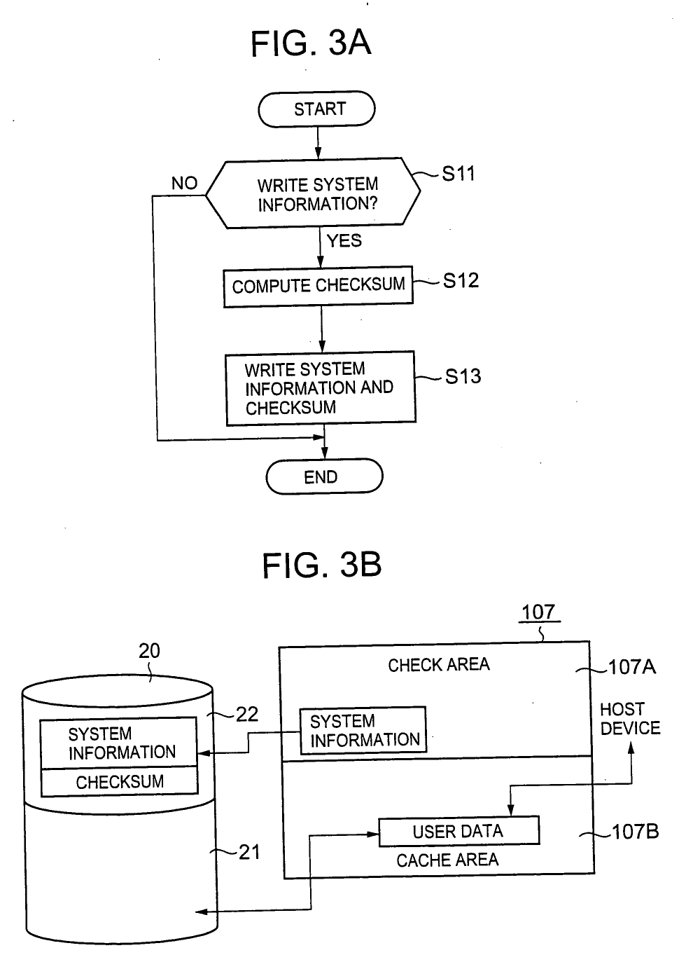

FIG. 3A shows an example of the flow of processing conducted by the CPU 101 writing system information.

When the CPU 101 writes system information to the system area 22 (YES in S11), the checksum for that system information is computed (S12), and the system information and the computed checksum are written to the system area 22 (S13).

System information includes such information elements as a microprogram (computer program) read and executed by the CPU 101, configuration information related to the storage device system 1, and trace information used for analysis when a fault occurs in the storage device system 1.

Configuration information includes, for example, case information (the number of expansion cases in the storage device system 1), cache information, HDD information (how many HDDs are mounted in which slots), RAID group information, LU information, port information (topology and the like), function information (which licensed functions can be used), pair information (which LUs are paired when copying from one LU to another LU, and the like), and parameter information (parameters such as whether or not verification is implemented when reading data online) Trace information includes, for example, information elements such as information indicating where a fault has occurred in the storage device system 1, which command was received from the management device 5, which processing was conducted automatically by the storage device system 1 (online verification and the like), and which kind of access request was received from which host device 3. The various information elements included in the trace information are associated with time information indicating the time at which a condition indicated by the information element occurred. Information elements other than those related to the prescribed interval before and after the time at which the fault occurred in the storage device system 1 may be deleted.

In addition to the afore-mentioned types of information elements, the system information includes, for example, various types of status retention information of the storage device system. In practice, for example, by storing indication that processing such as LU formatting and remote copying and the like have been interrupted as a type of system information in the system area 22, processing can be recommenced, and maintenance work can be conducted by storing HDD faults and the like in the system area 22.

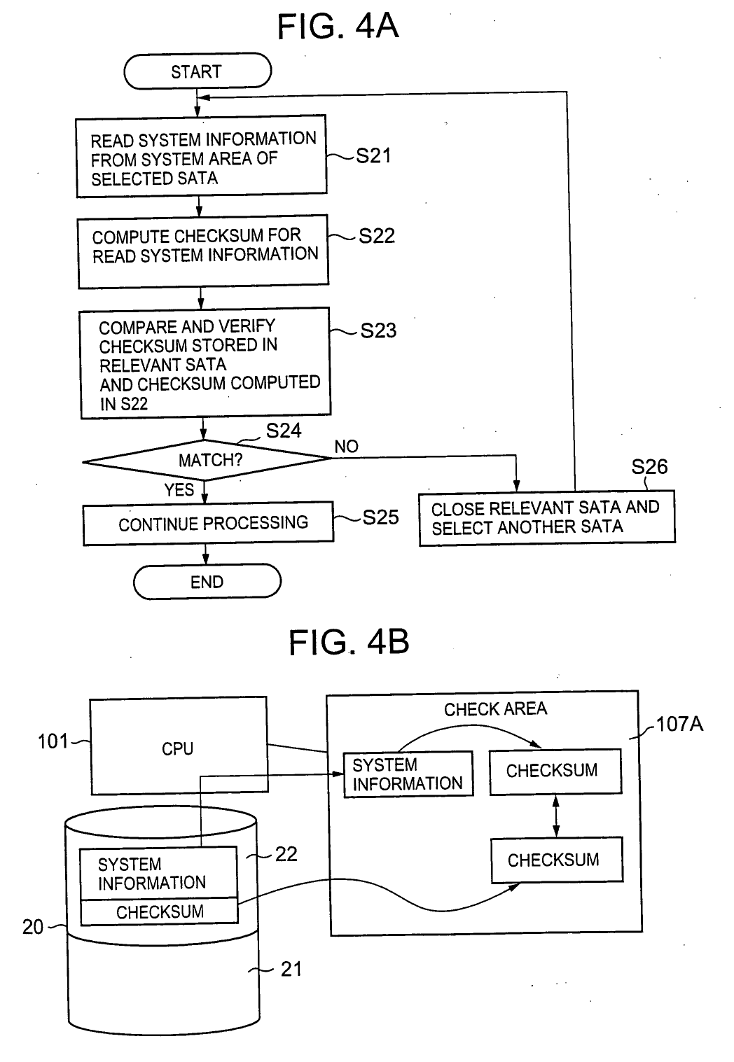

Of the afore-mentioned various types of information elements, computer programs and configuration information, for example, are written by the CPU 101 to the system area 22 received from the management device 5. Trace information is written to the system area 22 by the CPU 101 each time the prescribed event occurs. The CPU 101 can conduct the processing S12 and S13 shown in FIG. 3A each time all or part of the system information is updated. As shown in FIG. 3B, a checksum is computed for each system information in the system area 22 (in other words, for each system area) with the processing S12 and S13. As shown in FIG. 3B, when writing, the system information is temporarily stored in the cache memory 107, and the temporarily stored system information is then written to the system area 22. The cache memory 107 has, in addition to a cache area 107B in which user data sent and received between the host device 3 and the user area 21 is temporarily stored, a check area 107A. System information is temporarily stored in this check area 107A. Using the processing described in FIG. 4A below, the CPU 101 can delete the system information stored in the check area l07A when system information read from the system area 22 is determined as free from errors.

FIG. 4A shows an example of the flow of processing conducted by the CPU 101 when reading system information, and FIG. 4B is a descriptive diagram showing an example of that processing.

The CPU 101 selects one SATA HDD 20 of the plurality of SATA HDDs 20 (for example, the plurality of SATA HDDs 20 comprising a single RAID group), and reads system information from the system area 22 of the selected SATA HDD 20 to the check area 107A (S21).

Next, the CPU 101 computes the checksum from the system information stored in the check area 107A (S22), and writes the computed checksum to the check area 107A.

Next, the CPU 101 reads the checksum from the system area 22 being the source from which the system information is read in S21, and compares and verifies the read check sum and the check sum computed in S22 (S23).

When a match is obtained as a result of the comparison and verification in S23 (YES in S24), the CPU 101 continues processing (S25). In practice, for example, the CPU 101 executes processing based on the system information read in S21.

On the other hand, when a match is not obtained as a result of the comparison and verification in S23 (NO in S24), by CPU101 the SATA HDD 20 being the read source of the system information in S21 is closed, and another SATA HDD 20 (for example, another SATA HDD 20 comprising the same RAID group) is selected (S26), and S21 executed again. The term ‘close the SATA HDD’ can refer to, for example, shutting off power to the SATA HDD 20, or changing the status of the SATA HDD 20 in the table (for example, the table on which control by the CPU 101 is based) managing the status of the HDD from ‘in operation’ to ‘halted’.

The first embodiment has been described above. In this first embodiment, the microprogram for conducting the processing in FIG. 3A and FIG. 4A is stored in the memory 102, the processing in FIG. 3A and FIG. 4A is conducted in accordance with the microprogram stored in the memory 102, and processing may be conducted in accordance with the microprogram after the system information is determined as free from errors.

According to the afore-mentioned embodiment, the checksum for the system information written to the system area 22 is computed, and the checksum and system information written to the system area 22. Before the system information is read from the system area 22 and operation conducted based on that system information, the read system information is determined for the presence and absence of errors using the checksum for that system information, and if an error is found, operation is not conducted based on that system information. Thus, system information is written to the SATA HDD 20, and even if system information is read from the SATA HDD 20 and operation conducted, a malfunction based on the system information can be prevented. In other words, even if system information is written to the SATA HDD 20, reliability of the system information can be maintained.

### Second Embodiment

The second embodiment is described below. Differences with the first embodiment are primarily described in the following description, and description of points in common with the first embodiment are simplified or omitted (the same applies to the description of the third and later embodiments).

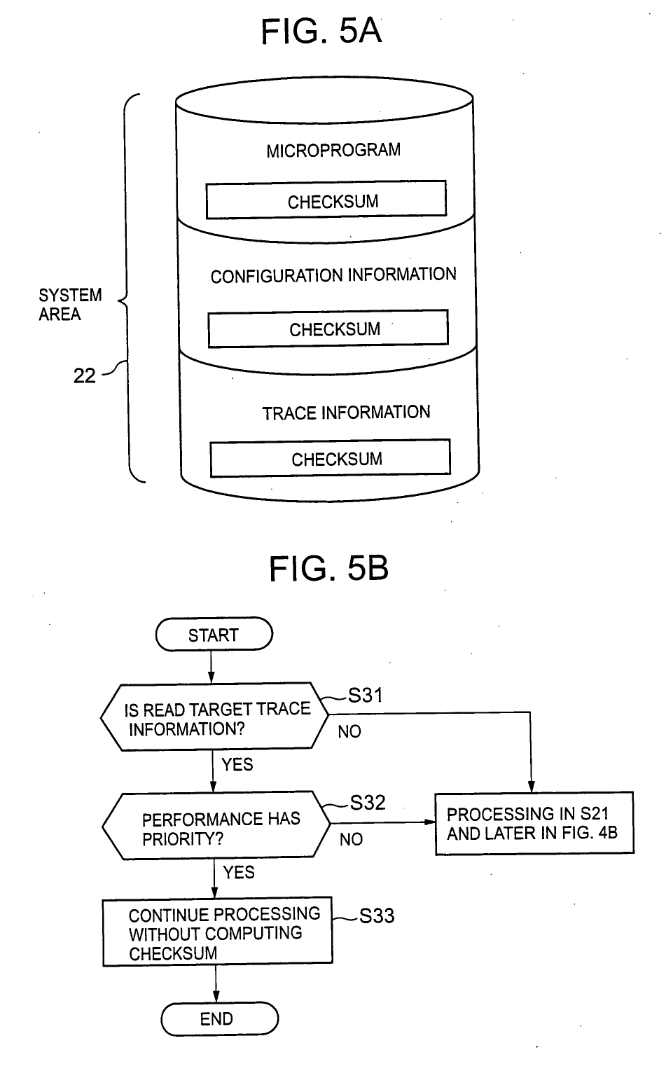

FIG. 5A shows a configuration example of the system area 22 in the second embodiment of the present invention. In this second embodiment, it is assumed that three types of information elements being a microprogram, configuration information, and trace information are included in the system information.

In the second embodiment, the checksum is computed for function elements of differing update timing, rather than for one system information, and stored in the system area 22. In practice, for example, in the second embodiment, since the microprogram, configuration information, and trace information have differing update timing, the microprogram checksum, the configuration information checksum, and the trace information checksum are each written to the system area 22. In the second embodiment, the processing S12 and S13 in FIG. 3A can be conducted for each type of information element.

The frequency with which information elements are updated increases in the order of microprogram, configuration information. In other words, in this embodiment, of the microprogram, configuration information, and trace information, the update frequency for trace information is the highest, the update frequency for configuration information is lower, and the update frequency for the microprogram is the lowest.

FIG. 5B shows an example of the flow of processing conducted by the CPU 101 when reading system information in the second embodiment of the present invention.

When the read target is not trace information but another type of information element (NO in S31), the CPU 101 conducts the processing S21 and later in FIG. 4A, in other words, the CPU 101 determines the presence and absence of errors of the read target information element.

On the other hand, when the read target is trace information (YES in S31), and performance of the storage device system 1 (for example, speed of processing access requests) rather than reliability of trace information has priority (YES in S32), the CPU 101 reads trace information and continues processing using that read trace information without computing the checksum of the read trace information (S33). When the afore-mentioned performance does not have priority, the processing in S21 and later in FIG. 4B is executed for the trace information as well. The CPU 101 can set whether or not to give priority to performance of the storage device system 1 in a storage area such as the memory 102 and the like in accordance with an instruction from, for example, the host device 3 or the management device 5, and by referencing that storage area, can determine whether or not to give priority to performance of the storage device system 1.

According to the second embodiment, a checksum is computed for each information element, rather than for each system information (in practice, for each update timing). Thus, for example, when an information element is updated., the load on the CPU 101 can be controlled since a checksum need not be computed for all system information following update.

Furthermore, in the second embodiment, when performance of the storage device system 1 rather than reliability of trace information has priority, trace information is not determined for the presence and absence of errors. More practically, since the microprogram and configuration information are related to operation of the storage device system 1, the microprogram and configuration information are determined for the presence and absence of errors before conducting operation based on the microprogram and configuration information. On the other hand, since trace information is used for analysis of faults rather than being related to operation of the storage device system 1, it is not always necessary to determine the presence and absence of trace information errors. Thus, efficient error determination can be conducted in consideration of the performance of the storage device system 1.

### Third Embodiment

The third embodiment of the present invention is described below.

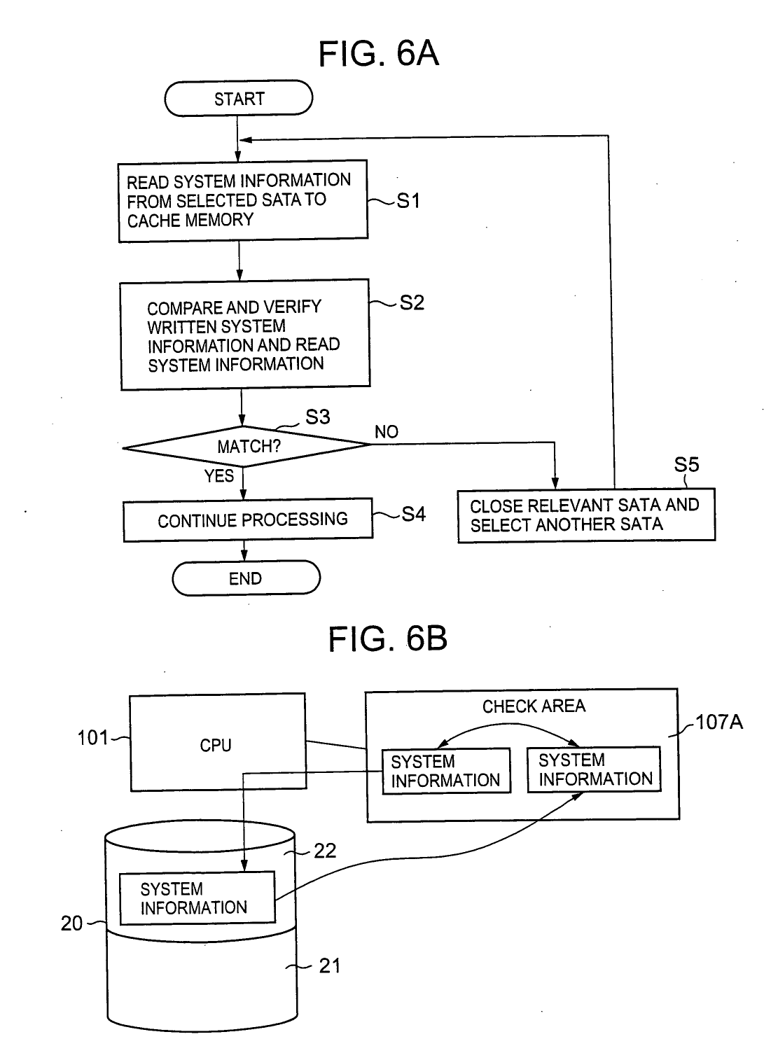

FIG. 6A shows an example of the flow of processing conducted by the CPU 101 reading system information in the third embodiment of the present invention, and FIG. 6B is a descriptive diagram of an example of that processing flow.

The CPU 101 selects a SATA HDD 20 from a plurality of SATA HDDs 20 (for example, a plurality of SATA HDDs 20 comprising a RAID group), and reads system information from the system area 22 of the selected SATA HDD 20 to the check area 107A (S1) The CPU 101 compares and verifies the written system information stored in the check area 107A and the system information read in S1 (S2).

When a match is obtained from the comparison and verification in S2 (YES in S3), the CPU 101 continues processing (S4), and when a match is not obtained (NO in S3), the same processing as in S26 in FIG. 4A is conducted (S5), and S1 is executed again.

The processing in FIG. 6A may be conducted by system information type, update timing, or read timing.

### Fourth Embodiment

The fourth embodiment of the present invention is described below.

In the fourth embodiment, a data guarantee code (hereafter referred to as a ‘guarantee code’) is used in place of the checksum. The data guarantee code may be any type of code. In practice, for example, the data guarantee code may be an ECC (Error Correcting Code) or an LRC (Longitudinal Redundancy Check) code.

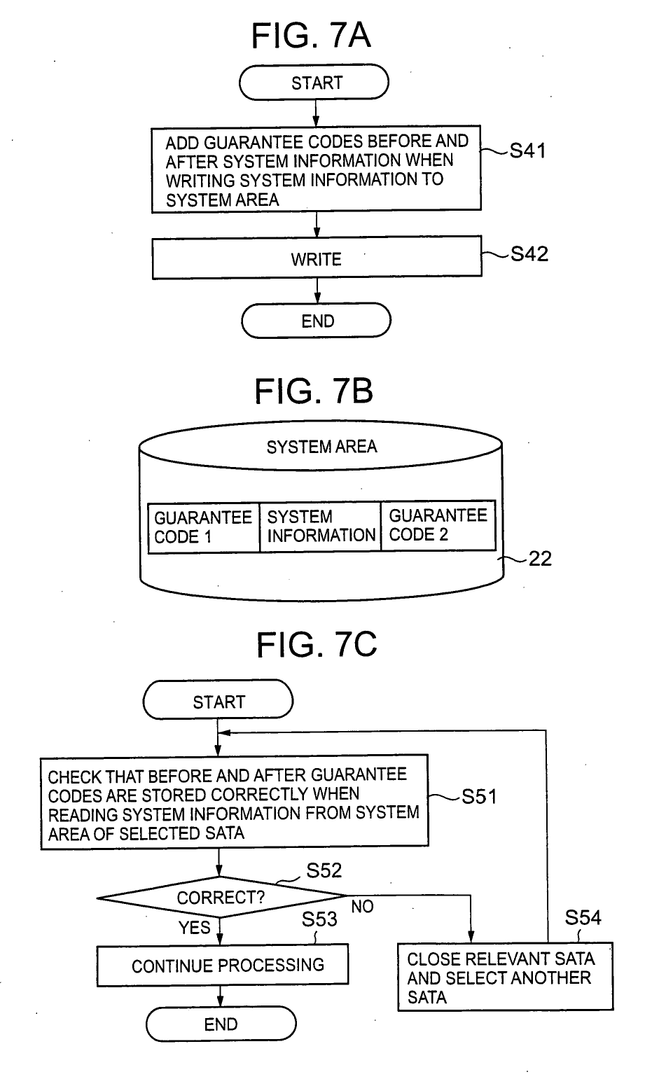

FIG. 7A shows an example of the flow of processing conducted by the CPU 101 writing system information in the fourth embodiment of the present invention.

When the CPU 101 writes system information to the system area 22, guarantee codes are generated and added before and after the system information (S41). As shown in FIG. 7B, system information to which guarantee codes are added is written to the system area 22 (S42).

FIG. 7C shows an example of the flow of processing conducted by the CPU 101 when reading system information in the fourth embodiment of the present invention The CPU 101 selects a SATA HDD 20 from a plurality of SATA HDDs 20 (for example, a plurality of SATA HDDs 20 comprising a RAID group), and reads the two guarantee codes either side of the system information in the system area 22 of the selected SATA HDD 20 to the check area 107A, compares and verifies the two guarantee codes (S51). When a match is obtained from the comparison and verification, the CPU 101 continues processing based on the system information (S53), and when a match is not obtained, the same processing as in S26 in FIG. 4A is conducted (S54), and S51 is executed again.

In the examples FIG. 7A through FIG. 7C, two guarantee codes are added to a single system information. Guarantee codes may also be generated by system information type, update timing, or read timing.

### Fifth Embodiment

The fifth embodiment of the present invention is described below.

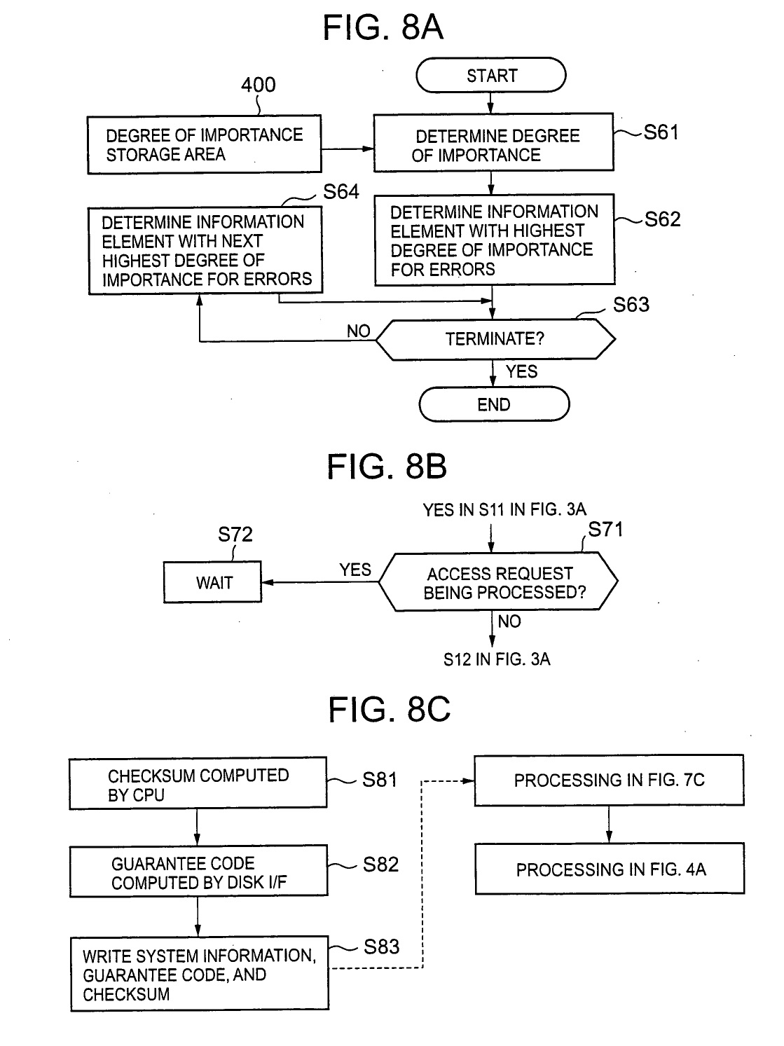

FIG. 8A shows an example of the flow of processing conducted in the fifth embodiment of the present invention.

Degree of importance information indicating the degree of importance of each type of information element (or of each sub-information element in each information element) in the system information is stored in the degree of importance storage area 400 (for example, an area in the memory 102).

The CPU 101 references the degree of importance information in the degree of importance storage area 400, and determines the degree of importance of each information element (S61). The CPU 101 determines the information element having the highest degree of importance for errors (for example, processing as shown in FIG. 4A) (S62).

If there are other information elements to be determined for errors (NO in S63), the CPU 101 determines the information element having the next highest degree of importance for errors (S63), and terminates processing if there are no information elements to be determined for the presence and absence of errors (YES in S63)

### Sixth Embodiment

The sixth embodiment of the present invention is described below.

In the sixth embodiment, when access requests from the host device 3 are not processed (in other words, when the load on the CPU 101 is small), system information can be written or determined for the presence and absence of errors.

In practice, for example, as shown in FIG. 8.B, following YES in S11 in FIG. 3A, the CPU 101 determines the access request from the host device 3 to determine whether or not this request is being processed (S71). If the access request is not being processed (NO in S71), S12 in FIG. 3A is conducted, and if the access request is being processed (YES in S71), the CPU 101 waits at least until that processing is completed, and conducts S12 in FIG. 3A.

### Seventh Embodiment

The seventh embodiment of the present invention is described below.

In the seventh embodiment, a plurality of types of error present/absent determination codes can be used together. In practice, for example, a checksum and guarantee code can be used together.

More practically, for example, as shown in FIG. 8C, when writing system information, the checksum for the system information can be computed by the CPU 101, or in other words, by the microprogram (S81). The guarantee code can then be computed by the disk I/F 106, or in other words, the hardware circuit (S82). Thus, both a checksum and data guarantee code are written to the system area 22 for each system information (for example, system information for which a guarantee code is added before and after the system information and checksum set is written).

For example, the processing in FIG. 7C can then be conducted, and when the guarantee codes match, the processing in FIG. 4A can be conducted.

### Eighth Embodiment

The eighth embodiment of the present invention is described below.

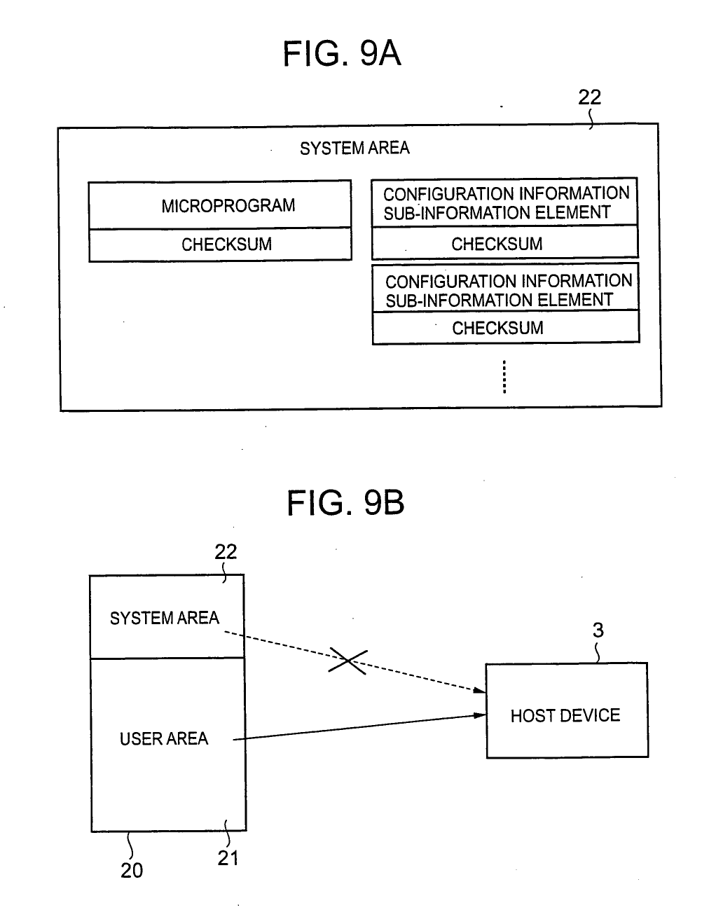

In the eighth embodiment, a checksum is stored in the system area 22 for each sub-information element comprising an information element for at least one information element in the system information. In practice, for example, as shown in FIG. 9A, since the update frequency of the microprogram is low, a checksum is not written to each sub-information element, the update frequency of the configuration information is higher than for the microprogram, and since the update frequency differs for each sub-information element, a checksum is computed and written for each type of sub-information element comprising the configuration information.

A number of ideal embodiments of the present invention have been described above, however these embodiments are examples describing the present invention, and the scope of the present invention is not limited to these embodiments. The present invention may also be implemented in a variety of other forms.

For example, error checking of all or part of the system information may also be conducted in a storage area other than the memory 102 and the like.

Furthermore, as shown in FIG. 9B, the CPU 101 induces recognition of the LU 24 in the user area 21 by the host device 3, however the CPU 101 can also induce non-recognition of each system area 22 by the host device 3.

Furthermore, for example, determination of presence and absence of information errors can be conducted by read timing. In practice, for example, when read timing differs for each type of sub-information element of the system information, the CPU 101 can determine the presence and absence of errors of information elements by type of sub-information element (more practically, for example, as shown in FIG. 5A, a checksum can be provided for each type of sub-information element, and that checksum used in error determination). Furthermore, for example, when read timing for a plurality of sub-information elements in various types of information elements differs, error determination can be conducted for each of at least one sub-information element. Thus, for example, in some cases, error determination is conducted separately (for example, a checksum is provided) for at least two sub-information elements, and one other sub-information element, all of which are the same type of information element. Furthermore, for example, in some cases, error determination is conducted separately (for example, a checksum is provided) for at least two types of information elements (system information information elements) and another information element of another type. These cases are the same when error determination is conducted by update timing as described above.

Furthermore, for example, error determination of information may be conducted for each type of information element in system information (for example, a checksum may be computed for each information element), and for each sub-information element in each type of information element (for example, a checksum may be computed for each sub-information element).

Furthermore, for example, a sub-storage area may be provided in the system area 22 for each type of system information element.

Furthermore, separate inexpensive storage devices (for example, SAS (Serial Attached SCSI) HDDs, maybe mounted in place of, or in addition to, SATA HDDs.

What is claimed is:

1. A storage device system operating based on system information related to a storage device system comprising:
a storage device to which system information is written; and
a determination unit for determining the presence and absence of system information errors prior to operation based on the system information written to the storage device.

2. The storage device system according to claim 1, comprising:
a plurality of storage devices storing the same system information;
wherein when the determination unit determines that system information written to one of a plurality of storage devices has an error, the one storage device is closed, and the presence and absence of errors in system information written to another storage device is determined.

3. The storage device system according to claim 1, wherein the storage device to which the system information is written is a SATA hard disk drive or an SAS hard disk drive.

4. The storage device system according to claim 1, further comprising a write unit for writing the system information to the storage device,
wherein the determination unit reads the system information from the storage device, compares the read system information with the written system information, and determines an error if one system information does not match the other system information.

5. The storage device system according to claim 1, further comprising a write unit for writing the system information and an error present/absent determination code for that system information to the storage device;
wherein the determination unit reads the system information and the error present/absent determination code for that system information from the storage device, and uses the read error present/absent determination code to determine the presence and absence of system information errors.

6. The storage device system according to claim 5, wherein,
the error present/absent determination code is a checksum for the system information; and
the determination unit reads the system information and the checksum from the storage device, computes the checksum for the read system information, compares the computed checksum and the read checksum and determines an error when one checksum does not match the other checksum.

7. The storage device system according to claim 5, wherein,
the error present/absent determination code is at least two specific codes; and
the determination unit reads the system information and the two specific codes from the storage device, compares the two specific codes, and determines an error when one specific code does not match the other specific code.

8. The storage device system according to claim 1, wherein,
the system information includes a plurality of system information elements; and
the determination unit determines the presence and absence of errors for each of at least one system information element.

9. The storage device system according to claim 8, wherein,
each of at least one system information element of the plurality of system information elements has differing type, update timing, or read timing; and
the determination unit determines the presence and the absence of errors of system information element based on differing type, update timing, or read timing.

10. The storage device system according to claim 9, further comprising a write unit for writing the error present/absent determination code of at least one system information element to the storage device,
wherein error present/absent determination codes differ with regard to the system information elements by type of, update timing, or read timing.

11. The storage device system according to claim 8, wherein the determination unit selects whether or not to determine the presence and absence of errors in the prescribed system information element of a plurality of system information elements, and when determination is selected, determines the presence and absence of errors in the prescribed system information element.

12. The storage device system according to claim 11, wherein
the determination unit is a processor reading and executing a computer program;
the system information includes the computer program, configuration information related to the configuration of the storage device system, and analysis data for. analyzing faults occurring in the storage device system, as the plurality of system information elements; and
the determination unit always determines the presence and absence of errors of the computer program and the configuration information, and selects whether or not to determine the presence and absence of errors of the analysis data, and when determination is selected, the prescribed system information element is determined for the presence and absence of errors.

13. The storage device system according to claim 8, further comprising a storage area in which each degree of importance of a plurality of system information elements can be stored,
wherein the determination unit references the storage area and determines the presence and absence of errors of system information elements, beginning from the system information element having the highest degree of importance.

14. The storage device system according to claim 2, the storage device system being communicably connected to the host device sending access requests, and comprising:
a plurality of storage devices including the storage device to which system information is written;
a computing unit for computing error present/absent determination codes for all or part of the system information;
a write unit for writing system information and error present/absent determination codes to the storage device; and
a control unit reading and writing data to and from at least one of the plurality of storage devices based on access requests from the host device;
wherein the computing unit computes the error present/absent determination codes when processing based on access requests is not conducted by the control unit.

15. The storage device system according to claim 2, wherein,
the write unit writes the system information and a plurality of types of error present/absent determination codes to the storage device; and
the determination unit uses the plurality of types of error present/absent determination codes to determine the presence and absence of system information errors.

16. The storage device system according to claim 1, the storage device system being communicably connected to the host device sending access requests further, and comprising:
a plurality of storage devices including a storage device to which system information is written;
a control unit for reading and writing data to and from at least one of the plurality of storage devices based on access requests from the host device;
a cache area for temporarily storing data sent and received between at least one of a plurality of storage devices and the host device,
wherein the determination unit uses a storage area separate from the cache area for determination of the presence and absence of errors.

17. The storage device system according to claim 1, comprising a plurality of storage devices comprising a single RAID group and communicably connected to a host device sending access requests,
wherein each of at least two storage devices of the plurality of storage devices are divided into a system area in which system information is written, and a user area accessed by the host device according to access requests from the host device;
wherein the same system information is written to each system area; and
and wherein the storage device system can either induce the host device not to recognize each system area, or induce the host device to recognize each system area as a write-prohibited area.

18. A method for controlling the storage device system operating based on system information related to the storage device system, comprising the steps of:
writing the system information to at least one storage device; and
determining the presence and absence of errors of the system information prior to operation based on system information written to the storage device.

19. The method according to claim 18, wherein when an error is determined as a result of the determination of the system information written to one storage device of a plurality of storage devices, that storage device is closed, and system information written to another storage device is determined for the presence and absence of errors.

20. A recording media recording a computer program, wherein,
the computer program is read to a processor mounted in a storage device system operating based on system information related to the storage device system;
the computer program writes the system information to at least one storage device; and
the computer program determines the presence and absence of system information error prior to operation based on system information written to the storage device.
